(19) United States
(12) Patent Application Publication
(10) Pub. No.: US 2022/0130138 A1
(43) Pub. Date: Apr. 28, 2022

(54) TRAINING DATA GENERATION APPARATUS, METHOD AND PROGRAM

(71) Applicant: NIPPON TELEGRAPH AND TELEPHONE CORPORATION, Tokyo (JP)

(72) Inventors: Mariko ISOGAWA, Tokyo (JP); Dan MIKAMI, Tokyo (JP); Kosuke TAKAHASHI, Tokyo (JP); Yoshinori KUSACHI, Tokyo (JP)

(73) Assignee: NIPPON TELEGRAPH AND TELEPHONE CORPORATION, Tokyo (JP)

(21) Appl. No.: 17/429,547

(22) PCT Filed: Feb. 3, 2020
(86) PCT No.: PCT/JP2020/003846

§ 371 Date: Aug. 9, 2021

(30) Foreign Application Priority Data
Feb. 14, 2019 (JP) 2019-024288

(51) Int. Cl. G06V 10/774; G06V 10/24; G06T 5/00

(52) U.S. Cl. CPC G06V 10/7747; G06T 5/005; G06V 10/245

(57) ABSTRACT

A technique of generating training data which enables improvement of estimation accuracy compared to the related art is provided. A training data generation device includes an image acquisition unit 11 configured to acquire an image of an object on which three or more markers are pasted, a marker measurement unit 12 configured to measure a position of each marker in the image and generate position and attitude information which is information regarding a position and an attitude of the object on the basis of the position of each marker, a recovery region determination unit 13 configured to determine a recovery region for inpainting in the image on the basis of the position of each marker, an image inpainting unit 14 configured to remove each marker from the image on the basis of the recovery region, and a training data generation unit 15 configured to generate training data on the basis of the image in which each marker is removed and the position and attitude information.

### TECHNICAL FIELD

The present invention relates to a technique of generating training data to be used in learning of a model for estimating information regarding an object in an image.

### BACKGROUND ART

A method disclosed in Non-Patent Literature 1 is known as a method for estimating a three-dimensional position and an attitude of an object in an image which is input (see, for example, Non-Patent Literature 1).

It is known that this method requires a large amount of training data annotated with true value data such as a three-dimensional position and an attitude of an object in an image upon learning. Further, work of preparing this training data is extremely troublesome and expensive.

Meanwhile, use of a marker-based motion capture system which tracks some kinds of markers such as a retroreflective material enables easy measurement of a position and an attitude of an object in an image without the need of annotation by manpower.

### CITATION LIST

### Non-Patent Literature

Non-Patent Literature 1: Yu Xiang, Tanner Schmidt, Venkatraman Narayanan and Dieter Fox, “PoseCNN: A Convolutional Neural Network for 6D Object Pose Estimation in Cluttered Scenes”, Robotics: Science and Systems (RSS), 2018.

### SUMMARY OF THE INVENTION

### Technical Problem

However, this method lets a marker formed with a retroreflective material, or the like, come out in the image. As a result of a marker which is not included in an actual estimation target comes out in the image upon learning, there is a possibility that estimation accuracy may degrade.

The present invention is therefore directed to providing a training data generation device, method, and program for generating training data which enables improvement of estimation accuracy compared to the related art.

### Means for Solving the Problem

A training data generation device according to one aspect of the present invention includes an image acquisition unit configured to acquire an image of an object on which three or more markers are pasted, a marker measurement unit configured to measure a position of each marker in the image and generate position and attitude information which is information regarding a position and an attitude of the object on the basis of the position of each marker, a recovery region determination unit configured to determine a recovery region for inpainting in the image on the basis of the position of each marker, and an image inpainting unit configured to remove each marker from the image on the basis of the recovery region, and a training data generation unit configured to generate training data on the basis of the image in which each marker is removed and the position and attitude information.

### Effects of the Invention

It is possible to improve estimation accuracy compared to the related art by removing markers.

### BRIEF DESCRIPTION OF DRAWINGS

FIG. 1 is a view illustrating an example of a functional configuration of a training data generation device.

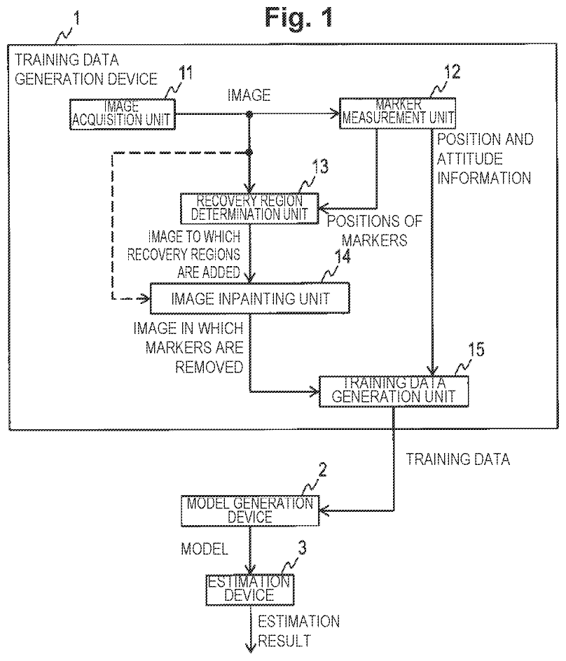

FIG. 2 is a view illustrating an example of processing procedure of a training data generation method.

FIG. 3 is a view illustrating an example of an image of an object on which markers are pasted.

FIG. 4 is a view illustrating an example of an image I_mask in a case where recovery regions are determined with (1) a determination method using specific color.

FIG. 5 is a view illustrating an example of an image I_mask in a case where recovery regions are determined with (2) a determination method using specific color.

FIG. 6 is a view illustrating an example of an image in which each marker is removed through inpainting.

FIG. 7 is a view illustrating an error in a case where inpainting has been applied and an error in a case where inpainting has not been applied, obtained through an experiment.

### DESCRIPTION OF EMBODIMENTS

An embodiment of the present invention will be described in detail below. Note that the same reference numerals will be assigned to components having the same functions in the drawings, and repetitive description will be omitted.

<Training Data Generation Device and Method>

A training data generation device 1 includes, for example, an image acquisition unit 11, a marker measurement unit 12, a recovery region determination unit 13, an image inpainting unit 14, and a training data generation unit 15.

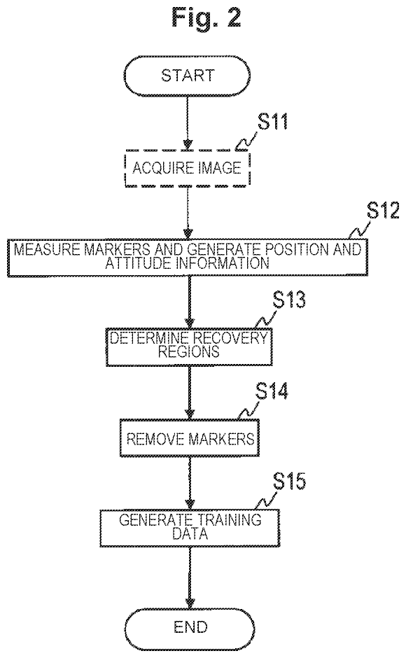

A training data generation method is implemented by, for example, the components of the training data generation device performing processing from step S11 to step S15 described below and illustrated in FIG. 2.

[Image Acquisition Unit 11]

The image acquisition unit 11 acquires an image of an object on which markers are pasted using C cameras c (c=1, . . . , C). C is a predetermined integer equal to or greater than 1.

The acquired image is output to the marker measurement unit 12 and the recovery region determination unit 13.

In this event, the image acquisition unit 11 may acquire images having variations in an attitude so that the images include a plurality of attitudes of the object. In other words, C may be a predetermined integer equal to or greater than 2. For example, the image acquisition unit 11 may acquire images of C or more different attitudes of the object using C cameras c (c=1, . . . , C) assuming that C=3.

Note that it is assumed that three or more markers are pasted on one object, because it is necessary to be able to uniquely identify the attitude with the markers pasted on the object.

Further, it is necessary to paste the markers as randomly as possible, for example, provide markers on a quadrangle having different lengths of sides, so as to avoid different attitudes from being identified with the same marker positions.

Further, while the number of markers is preferably larger, it is assumed that markers are pasted so that an area of the markers does not exceed 2/3 of an area of the object, so as to avoid the markers from covering texture of the object.

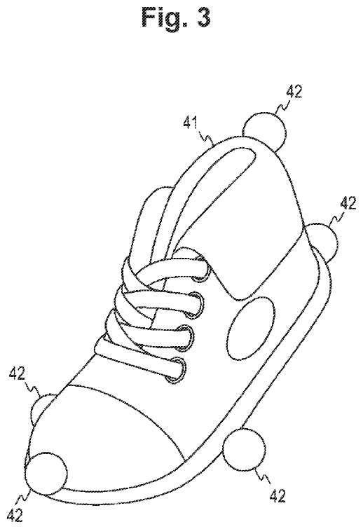

FIG. 3 is a view illustrating an example of an image of an object on which markers are pasted. In FIG. 3, five spherical markers 42 are attached to the surrounding of a sneaker 41 which is an object.

The image acquisition unit 11 acquires an image of the object on which three or more markers are pasted in this manner (step S11).

[Marker Measurement Unit 12]

The image acquired at the image acquisition unit 11 is input to the marker measurement unit 12.

The marker measurement unit 12 measures a position of each marker in the image and generates position and attitude information which is information regarding a position and an attitude of the object on the basis of the position of each marker (step S12).

The measured position of each marker is output to the recovery region determination unit 13. The generated position and attitude information is output to the training data generation unit 15.

Examples of the position of each marker in the image, which is to be measured by the marker measurement unit 12, can include a two-dimensional coordinate p₂(c)=(x_{2c}, y_{2c}) of each marker in the image captured with the camera c, where c=1, . . . , C.

The position and attitude information to be generated by the marker measurement unit 12 is at least one of two-dimensional position information of each marker, three-dimensional position information of each marker, two-dimensional position information of the object, three-dimensional position information of the object and attitude information of the object.

Which information should be included as the position and attitude information depends on information to be estimated at an estimation device 3 which will be described later. In other words, the position and attitude information includes at least information to be estimated at the estimation device 3.

The two-dimensional position information of each marker is, for example, a two-dimensional coordinate p₂(c)=(x_{2c}, y_{2c}) of each marker.

The three-dimensional position information of each marker is, for example, a three-dimensional coordinate p₃=(x₃, y₃, z₃) of each marker.

The two-dimensional position information of the object is a two-dimensional position of the object determined on the basis of the two-dimensional coordinate p₂(c)=(x_{2c}, y_{2c}) of each marker. For example, a geometric center of the two-dimensional coordinate p₂(c)=(x_{2c}, y_{2c}) of each marker is the two-dimensional position of the object.

The three-dimensional position information of the object is a three-dimensional position of the object determined on the basis of the three-dimensional coordinate p₃=(x₃, y₃, z₃) of each marker. For example, a geometric center of the three-dimensional coordinate p₃=(x₃, y₃, z₃) of each marker is the three-dimensional position of the object.

The attitude information of the object is an attitude v of the object which can be calculated from the three-dimensional coordinate p₃=(x₃, y₃, z₃) of each marker.

As a coordinate system of the attitude v, for example, a quaternion coordinate system (coordinate system expressed with four-dimensional vectors having a rotational axis and a rotational amount), a spherical polar coordinate system (coordinate system expressed with two-dimensional vectors expressed with two 1550108964325_0 coordinates), or the like, can be utilized. Of course, the coordinate system and a data format of the attitude v are not limited to these, and other coordinate systems and data formats may be used.

As a method for measuring a position of each marker, a motion capture system using a retroreflective material, a method of detecting and tracking color markers, or the like, can be used. Of course, the method for measuring a position of each marker is not limited to these, and other measuring methods may be used.

[Recovery Region Determination Unit 13]

The image acquired at the image acquisition unit 11 and the position of each marker measured at the marker measurement unit 12 are input to the recovery region determination unit 13.

The recovery region determination unit 13 determines recovery regions for inpainting in the image on the basis of the position of each marker.

Information regarding the determined recovery regions is output to the image inpainting unit 14. Examples of the information regarding the determined recovery regions can include an image I_mask which will be described later.

For example, the recovery region determination unit 13 determines recovery regions for applying inpainting by applying a mask to an image I which is acquired at the image acquisition unit 11 on the basis of a two-dimensional coordinate of each marker in the image I.

It is assumed that the recovery regions are pixels within a radius r from the position of each marker, that is, the two-dimensional coordinate p₂(c) of each marker. Here, it is assumed that the radius r is a constant set in advance so as to be large enough to hide the marker in the image and so as to be a minimum size.

For example, the recovery regions can be determined using the following method (1) or (2). Of course, a method for determining recovery regions is not limited to these, and methods other than the following methods (1) and (2) may be used.

(1) Determination Method Using Specific Color

Pixels within the radius r from the two-dimensional coordinate p₂(c) of each marker is painted with specific color (such as, for example, (R, G, B)=(255, 0, 255)) for an image obtained by copying the image I. Regions painted with the specific color become the recovery regions. In this case, the image in which the recovery regions are painted with the specific color becomes I_mask.

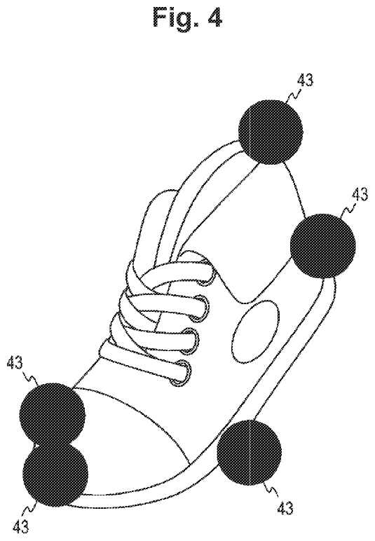

FIG. 4 is a view illustrating an example of the image I_mask in a case where the recovery regions are determined with (1) the determination method using specific color. In FIG. 4, the recovery regions 43 are painted with specific color of (R, G, B)=(255, 255, 255).

(2) Determination Method Using Binary Image

The image is expressed with two values by, for example, setting the regions painted with the specific color using the method (1) as (R, G, B)=(0, 0, 0) and setting other regions as (R, G, B)=(255, 255, 255). This image expressed with two values becomes I_mask.

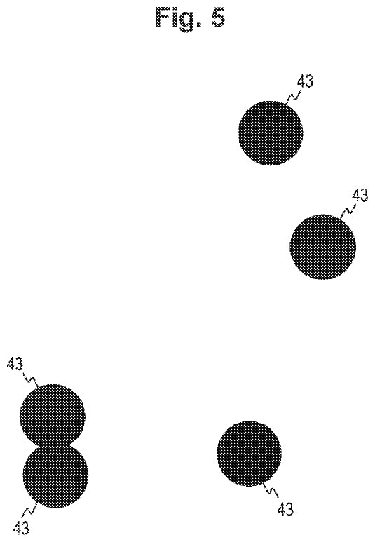

FIG. 5 is a view illustrating an example of the image I_mask in a case where the recovery regions are determined with (2) the determination method using specific color. In FIG. 5, the recovery regions 43 are painted with specific color of (R, G, B)=(0, 0, 0) and other regions are (R, G, B)=(255, 255, 255).

[Image Inpainting Unit 14]

Information regarding the recovery regions determined at the recovery region determination unit 13 is input to the image inpainting unit 14.

Note that in a case where the recovery region determination unit 13 determines the recovery regions using the method (1), an RGB image I_mask in which the recovery regions are painted with specific color is input to the image inpainting unit 14.

In contrast, in a case where the recovery region determination unit 13 determines the recovery regions using the method (2), it is assumed that the image I acquired at the image acquisition unit 11 in addition to the image I_mask expressed with two values are input to the image inpainting unit 14.

The image inpainting unit 14 removes each marker from the image on the basis of the recovery regions (step S14).

An image I_inpainted in which each marker is removed is input to the training data generation unit 15.

The image inpainting unit 14 removes each marker through inpainting. The inpainting is an image processing technique of complementing an unnecessary region in the image without providing a feeling of strangeness by utilizing other regions acquired from the same image or from a predetermined database.

As an inpainting method, for example, a method disclosed in Reference Literature 1 or Reference Literature 2 can be used. [Reference Literature 1] Kaiming He and Jian Sun, ‘Statistics of Patch Offsets for Image Completion’, ECCV, 2014 [Reference Literature 2] Mariko Isogawa, Dan Mikami, Kosuke Takahashi, Akira Kojima, ‘Image and video completion via feature reduction and compensation’, Volume 76, Issue 7, pp 9443-9462, 2017.

Of course, the inpainting method is not limited to these methods, and other inpainting methods may be used.

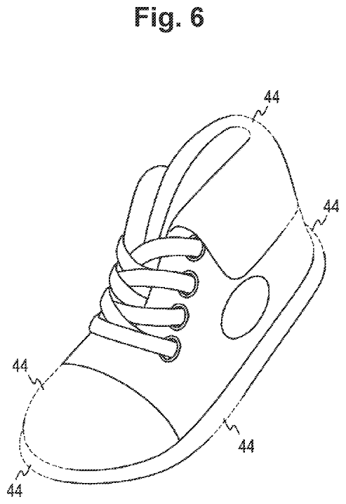

FIG. 6 is a view illustrating an example of an image in which each marker is removed through inpainting. FIG. 6 indicates portions 44 in which inpainting is applied with dashed lines.

[Training Data Generation Unit 15]

The image I_inpainted in which each marker is removed is input to the training data generation unit 15. Further, the position and attitude information generated at the marker measurement unit 12 is input to the training data generation unit 15.

The training data generation unit 15 generates training data D_train on the basis of the image I_inpainted in which each marker is removed and the position and attitude information (step S15).

The generated training data is output to a model learning device 2.

For example, the training data generation unit 15 generates the training data D_train by associating the image I_inpainted with the position and attitude information. It is assumed that the training data D_train includes the image I_inpainted and the position and attitude information associated with this image I_inpainted.

By removing markers not included in an actual estimation target in this manner, it is possible to generate training data which enables improvement of estimation accuracy compared to the related art.

Note that the model based on the training data D_train including the image I_inpainted in which markers are removed is generated by the model learning device 2 which will be described below. Further, estimation based on the model generated by the model learning device 2 is performed by the estimation device 3 which will be described later.

<Model Learning Device 2>

The training data D_train generated at the training data generation unit 15 is input to the model learning device 2.

The model learning device 2 generates a model by performing model learning on the basis of the training data D_train (step S2).

The generated model is output to the estimation device 3.

As a model learning method, for example, a method of Deep Neural Network disclosed in Reference Literature 3 can be used. Of course, the model learning method is not limited to this, and other model learning methods may be used.

More specifically, a plurality of pieces of training data D_train are input to the model learning device 2. The plurality of pieces of training data D_train include sets of a plurality of images I_inpainted which are obtained by capturing images of the same object with various attitudes (the captured images of the object preferably include at least three markers) and performing the above-described inpainting to remove markers, and position and attitude information respectively corresponding to the plurality of images I_inpainted.

For example, the training data D_train is data including a plurality of sets of images I_inpainted in which a given object takes different attitudes and two-dimensional position information of respective markers which are removed in the images I_inpainted.

In this case, when a captured image of an object which is the same as an object in the images I_inpainted included in the training data D_train is input, the model learning device 2 generates a model which outputs position and attitude information which is included in the training data D_train and which corresponds to an attitude of the object in the input image by learning a plurality of pieces of training data D_train.

The model learning device 2, for example, generates a model which outputs two-dimensional position information of predetermined positions (which do not exist in the input image, and which are positions of markers attached to the object of the training data) as the position and attitude information of the object of the input image in a case where the position and attitude information included in the training data D_train is the two-dimensional position information of each marker.

<Estimation Device 3>

The model generated at the model learning device 2 is input to the estimation device 3. Further, the image of the object which is an estimation target is input to the estimation device 3.

The estimation device 3 estimates and outputs the position and attitude information corresponding to the input image using the model (step S3).

A type of the estimated position and attitude information is the same as a type of information included in the position and attitude information learned at the model learning device 2 in association with the plurality of images I_inpainted. In other words, for example, in a case where the position and attitude information upon generation of the training data and the model is attitude information of the object, the position and attitude information to be estimated by the estimation device 3 is also the attitude information of the object.

### Experimental Result

An experimental result indicating effects of model learning using an image in which markers are removed through inpainting will be described below.

A model to which inpainting had been applied and a model to which inpainting had not been applied were respectively generated by performing model learning using an image (to which inpainting had been applied) in which markers had been removed by the above-described embodiment and an image (to which inpainting had not been applied) in which markers had not been removed, for approximately 15,000 training data images. These models are models which output attitude data expressed with a quaternion coordinate system. Errors between attitude data respectively estimated using these models and correct attitude data were calculated.

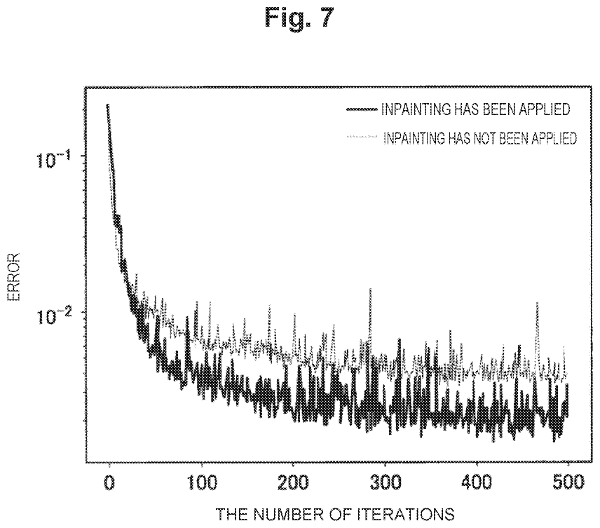

FIG. 7 is a view illustrating an error in a case where inpainting has been applied and an error in a case where inpainting has not been applied, obtained through the experiment.

FIG. 7 indicates the error in a case where inpainting has been applied with a solid line and indicates the error in a case where inpainting has not been applied with a dashed line. FIG. 7 indicates the number of iterations in a case where learning has been performed through deep learning on a horizontal axis and indicates a magnitude of an error on a vertical axis.

It can be known that errors can be reduced by performing model learning using an image in which markers are removed through inpainting. Further, it can be known that learning of a network effectively proceeds by removing markers through inpainting.

### Modified Examples

While the embodiment of the present invention has been described above, a specific configuration is not limited to the embodiment, and it goes without saying that change of design, and the like, within the range not deviating from the gist of the present invention are included in the present invention.

Various kinds of processing described in the embodiment may be executed in parallel or individually in accordance with processing performance of devices which execute the processing or as necessary as well as being executed in chronological order in accordance with described order.

For example, the components of the training data generation device may directly exchange data or may exchange data via a storage unit which is not illustrated.

[Program, Recording Medium]

In a case where various kinds of processing functions at the respective devices described above are implemented with a computer, processing of the functions that the respective devices should have is described with a program. Further, the various kinds of processing functions at the respective devices described above are implemented on the computer by this program being executed at the computer.

This program which describes the processing can be recorded in a computer-readable recording medium. Examples of the computer-readable recording medium can include anything, for example, a magnetic recording device, an optical disk, a magnetooptical recording medium, a semiconductor memory, and the like.

Further, this program is distributed by, for example, a portable recording medium such as a DVD and a CD-ROM in which the program is recorded being sold, given, lent, or the like. Still further, it is also possible to employ a configuration where this program is distributed by storing the program in a storage device of a server computer and transferring the program from the server computer to other computers via a network.

A computer which executes such a program, for example, first, stores a program recorded in the portable recording medium or a program transferred from the server computer in a storage device of the own computer once. Then, upon execution of the processing, this computer reads the program stored in the storage device of the own computer and executes the processing in accordance with the read program. Further, as another execution form of this program, the computer may directly read a program from the portable recording medium and execute the processing in accordance with the program. Still further, the computer may sequentially execute the processing in accordance with the received program every time the program is transferred from the server computer to this computer. Further, it is also possible to employ a configuration where the above-described processing is executed by so-called ASP (Application Service Provider) type service which implements processing functions only by an instruction of execution and acquisition of a result without the program being transferred from the server computer to this computer. Note that, it is assumed that the program in the present form includes information which is to be used for processing by an electronic computer, and which is equivalent to a program (not a direct command to the computer, but data, or the like, having property specifying processing of the computer).

Further, while the present device is constituted by a predetermined program being executed on the computer, at least part of the processing may be implemented with hardware.

### REFERENCE SIGNS LIST

1 Training data generation device
11 Image acquisition unit
12 Marker measurement unit
13 Recovery region determination unit
14 Image inpainting unit
15 Training data generation unit
2 Model learning device
3 Estimation device
41 Sneaker
42 Marker
43 Recovery region
44 Portion in which inpainting is applied

1. A training data generation device comprising:
processing circuitry configured to acquire an image of an object on which three or more markers are pasted;
measure a position of each marker in the image and generate position and attitude information which is information regarding a position and an attitude of the object on a basis of the position of each marker;
determine a recovery region for inpainting in the image on a basis of the position of each marker;
remove each marker from the image on a basis of the recovery region; and
generate training data on a basis of the image in which each marker is removed and the position and attitude information.

2. The training data generation device according to claim 1,
wherein the position and attitude information is at least one of two-dimensional position information of each marker, three-dimensional position information of each marker, two-dimensional position information of the object, three-dimensional position information of the object and attitude information of the object.

3. A training data generation method comprising:
an image acquisition step of an image acquisition unit acquiring an image of an object on which three or more markers are pasted;
a marker measurement step of a marker measurement unit measuring a position of each marker in the image and generating position and attitude information which is information regarding a position and an attitude of the object on a basis of the position of each marker;
a recovery region determining step of a recovery region determination unit determining a recovery region for inpainting in the image on a basis of the position of each marker;
an image inpainting step of an image inpainting unit removing each marker from the image on a basis of the recovery region; and
a training data generation step of a training data generation unit generating training data on a basis of the image in which each marker is removed and the position and attitude information.

4. A non-transitory computer readable medium that stores a program for causing a computer to perform respective steps of the training data generation method according to claim 3.
